(19) United States
(12) Patent Application Publication
(10) Pub. No.: US 2015/0039424 A1
(43) Pub. Date: Feb. 5, 2015

(54) SYSTEM AND METHOD FOR SOCIAL DISPLAY ADVERTISEMENTS

(71) Applicant: YAHOO! INC, Sunnyvale, CA (US)

(72) Inventors: Sundeep Narravula, Sunnyvale, CA (US); Rahul Chugh, Santa Clara, CA (US); Supreeth Rao, Sunnyvale, CA (US); Shivakumar Ningappa, Milpitas, CA (US)

(73) Assignee: YAHOO! INC, Sunnyvale, CA (US)

(21) Appl. No.: 13/953,870

(22) Filed: Jul. 30, 2013

(51) Int. Cl. G06Q 30/02

(52) U.S. Cl. CPC G06Q 30/0255; G06Q 30/0257
USPC 705/14.53; 705/14.55

(57) ABSTRACT

Disclosed is a system and method for providing automated micro-targeted advertisements to a small group of engaged users based on the users' interactions with each other. The systems and methods disclosed provide relevant advertisements to members of a small targeted online group, where the members of the group share common interests, behaviors, preferences, online activities, and the like. The advertisements include calls to action for a receiving user to consummate a transaction, which encourages product (or brand) engagement by specifically identifying friends (or other users who have an established relationship with the user) that may be interested in a product, thereby, providing an initial dialogue between the friends over the targeted product.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to serving advertisements to a group of users, and more particularly, to methods and systems for serving micro-targeted advertisements to a small group of contextually related users.

### RELATED ART

On-line “group-buying” (or collective buying) advertising may be used to accomplish various business goals, ranging from building brand awareness among potential customers to facilitating on-line purchases of products and/or services. Group buying offers products and services at significantly reduced prices on the condition that a minimum number of buyers would make the purchase. Currently, group-buying websites have emerged as a major player in online shopping business. Typically, these websites (or services), e.g., Groupon® and LivingSocial®, feature a deal of the day, with the deal kicking in once a set number of people agree to buy the product or service. Buyers then print off a voucher to claim their discount at the retailer. Many of the group-buying sites work by negotiating deals with local merchants and promising to deliver crowds in exchange for discounts.

### SUMMARY

The present disclosure addresses failings in the art by providing a system and method for serving micro-targeted advertisement materials, such as group sales offers, to a small, highly engaged number of people. Conventional group-buying advertising involves deals that are generic and simply require a minimized group size. Additionally, the purchasing activity of the group-buying ads is not specifically tied to a set of individuals. The present disclosure discloses identifying a highly engaged user group, and targeting the user group with contextually relevant advertisements. Advertisements served to the user group are based on the nature of the user groups' engagement, and/or accumulated characteristics, activities and behaviors of the group, and/or of those users within the group. Serving advertisements in this manner reduces costs, increases click-through rates (CTR), increases revenue or return on investment (ROI), and increases efficiency.

In accordance with one or more embodiments, a method is disclosed which includes determining, via a computing device, connections over a network between a first user and a plurality of other users, said determination of said connections comprising identifying a plurality of communication channels used for interactions between said first user and said other users; determining, via the computing device, user pairs based on said connections, each user pair comprising said first user and one of said other users, each pair associated with at least one communication channel of said plurality of communication channels; computing, via the computing device, an engagement score for each user pair, said engagement score is based upon a level of interaction occurring between said first user and each other user over each associated communication channel; determining, via the computing device, an overall engagement score for each user pair, said determination of the overall engagement score comprising combining each engagement score from each associated communication channel for each user pair; identifying, via the computing device, a top pair based upon the overall engagement score for each pair; determining, via the computing device, a shared interest associated with said top pair; and generating, via the computing device, an advertisement for said top pair based on said shared interest.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for serving micro-targeted advertisements to a small group of contextually related users.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic diagram illustrating components for generating social display ads in accordance with some embodiments of the present disclosure;

FIG. 4 is a flowchart illustrating steps performed in accordance with some embodiments of the present disclosure;

FIG. 5 is a flowchart illustrating steps performed in accordance with some embodiments of the present disclosure;

FIGS. 6A-6B are examples of social display ads in accordance with some embodiments of the present disclosure; and

FIG. 7 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many different forms. Typically, advertisements target users with specific products/services (or brands) via a specific deal or a coupon. A small percentage of these ads result in purchases. In addition, a small number of these ads/deals result in positive user engagement. One type of current deal scheme implemented to engage users is a “buy one get one free” deal. This type of deal is agnostic to the identity of groups of users, and is not provided as a group deal. That is, the deal was created solely respective as a means to generate profit for a service or store, where if any user buys one item, they can then purchase another item (typically of lesser value) for free. Additionally, the interests, activities and/or characteristics of the deal are irrelevant, as the user holds the key to whether or not the deal will be consummated. That is, if the user is not interested, the deal remains for other users. Also, the deal is not tailored to any user's needs, interests or desires. In a similar scope, “refer a friend” discounts, lack the targeted nature of the deals discussed herein.

Another conventional type of deal is a “group-buying” deal published by a group-buying site/service. Typically, group-buying sites publish various offers to sell different items such as products or services. The items of each offer are marked down from normal prices to discounted prices. Each offer is contingent upon acceptance by a minimum number of people, which is typically stated in the published offer. The basic premise of the conventional group-buys is that a large group agrees to buy a particular item, where the buyers of the group all reap a significant discount. When the specified number of people accept an offer, this forms a deal and the seller becomes obligated to provide the offered product/service at the price pre-announced in the offer. These conventional group-buying sites/services are only able to increase user engagement through more striking deals in order to amass a large body of customers.

As an example of a conventional group-buying deal, provided by a service, e.g., Groupon®, includes an offer to sell a Kayaking class for $75, which is a discounted price from the normal price at $125. The offer requires thirty participants to accept in order for the deal to become effective. A group buying Web site publishes the offer directly on their Web site, or by distributing emails describing the offer. Thousands of people view the offer via Web site or email, and during this time, interested parties accept the offer using a “buy” button or other graphical user interface (GUI) feature provided in the Web site or email. The group buying Web site continually tallies the total number of acceptances, and provides an updated count via the Web site. When the number of acceptances reaches thirty, the offer may be closed, or it may continue for some time while others can still join in. When the offer closes, the group buying Web site issues coupons to the buyers, each coupon good for the right to purchase the Kayaking class for $75 instead of the normal $125.

Thus, within the present targeted advertisement landscape, there are failings in the art related towards providing advertisements that specifically call out small groups of users (or people) with contextually targeted ads. The present disclosure provides an automated system and method to improve user engagement around purchasing by creating (and/or delivering) social display advertisements that identify a user's friends with a targeted product. The systems and methods discussed herein provide relevant advertisements to members of a targeted online group, whose members share common interests, behaviors, preferences, online activities, and the like. In preferred embodiments, as discussed in more detail below, the groups of users include two (or few) users. Thus, the present disclosure provides for specifically calling out two (or few) users in a small group. This encourages product (or brand) engagement by specifically identifying “friends” that may be interested in a product; thus, providing an initial dialogue between the friends over the targeted product.

By way of a non-limiting example, after analysis of users Scott and John, it is determined that they are both interested in an Xbox®. Based on such information, specific advertisements can be created for at least Scott and/or John. For example, Scott may receive an advertisement calling out Scott as follows, “If you and John both purchase an Xbox each, you will get it for a discount of 20% and you will get a multi-player online game for free.” In some embodiments, a similar ad can be shown to John as well. Thus, in this scenario, the present disclosure is not only addressing or targeting Scott for his interest in a product, but also strongly suggesting that the user chat with (or interact with) John about the product.

Thus, the present disclosure encourages positive user engagement within a monetization context related to user purchases. That is, by specifically calling out a group discount for highly engaged groups, such as but not limited to, husband and wife, friends that interact daily, and the like, the present disclosure encourages and facilitates the identified individuals to discuss and interact with each other with the product/service as the foundation for such interaction. This is an extremely important factor for advertisers and their campaigns as it increases the likelihood of a purchase/action by moderately interested individuals. That is, if a user's peers are interested, or highly motivated respective a product/service, that user would then most likely be interested. Therefore, advertisers can explicitly leverage relationships between users by capitalizing on each user's influence on the other. Additionally, the increased personalization of advertisements enables such ads to be contextually related to interests shared between users. Thus, for a given product, conversion rates of marginally interested users can improve as such users can be paired with serious and highly interested “friends” looking to buy that product.

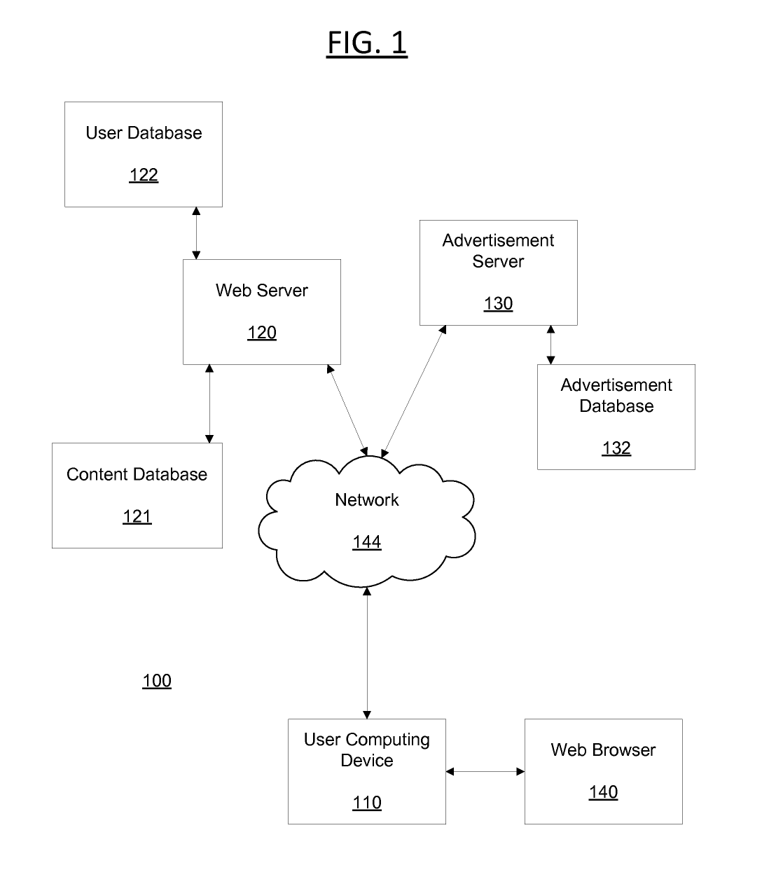

Certain embodiments will now be described in greater detail with reference to the figures. In general, with reference to FIG. 1, a system 100 in accordance with an embodiment for providing a personalized advertisement is shown. The user can access content from a user computing device 110. The content may be provided by web server 120 over network 144. Thus, in order to provide the content, the web server 120 may be associated with a content database 121 (or repository). Content within the content database 121 can include media or multimedia, and such content may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, and the like.

Thus, it should be understood that the web server 120 can be referred to as a “content server.” A content server may include a device that includes a configuration to provide content via a network to another device. A content server may, for example, host a site, such as a social networking site, examples of which may include, without limitation, Flickr®, Twitter®, Facebook®, LinkedIn®, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, and the like.

According to some embodiments, the present disclosure may also be utilized within a social network. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks.

In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

An advertisement may be served to user computing device 110 from advertisement server 130 over the network 144. Each of user computing device 110, web server 120 and advertisement server 130 can be communicatively coupled via the network 144, such as the Internet. Although different steps are being performed by the web server 120 and the advertisement server 130, it should be noted that any one or more of the steps can be performed by either of the web server 130 and the advertisement server 130, or the function can be combined in a single server.

In accordance with some embodiments, the ad server 130 and the web server 120 can be a single server or multiple servers, and can be at a single location or multiple locations. Portions of advertisement content and advertising metadata may be stored at advertisement database 132. Advertising content and metadata can be accessed by and served from advertisement server 130 to the user computing device 110 based upon keywords, tags or other information known about each portion of content being transmitted by the web server 120. Additionally, ad content and metadata can be served based on user information, which is stored at user database 122, as is described in further detail below.

The user database 122 may be based upon a profile builder, as understood by those of skill in the art. A profile builder may initiate generation of a profile, such for users of an application, including a search engine, for example. A profile builder may initiate generation of a user profile for use, for example, by a user, as well as by an entity that may have provided the application. For example, a profile builder may enhance relevance determinations and thereby assist in indexing, searching or ranking served advertisements, search results, and the like. Therefore, an ad serving engine, or a search engine provider may employ a profile builder, for example.

A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

User computing device 110 includes a web browser 140, or other program for interfacing with the network. The web server 120 provides content, e.g., Web pages, which are accessible by the user computing device 110. One of the Web pages includes reference to the advertisement. Such an advertisement, which may contain portions written in HTML, XML, Macromedia Flash, Java, JavaScript, and the like, is served by advertisement server 130, as is generally known in the art.

It is to be understood that the present disclosure may be implemented utilizing any number of computer technologies. For example, although certain embodiments relate to providing access to content via the Internet, the disclosure may be utilized over any computer network, including, for example, a wide area network, local area network or, corporate intranet. Similarly, the user computing device 110 may be any computing device that may be coupled to the network 144, including, for example, personal computers, game consoles, smart TVs, personal digital assistants, Web-enabled cellular telephones, devices that dial into the network, mobile computers, tablet computers personal computers, Internet appliances, wireless communication devices and the like. Furthermore, the servers described herein may be of any type, running any software, and the software modules, objects or plug-ins may be written in any suitable programming language

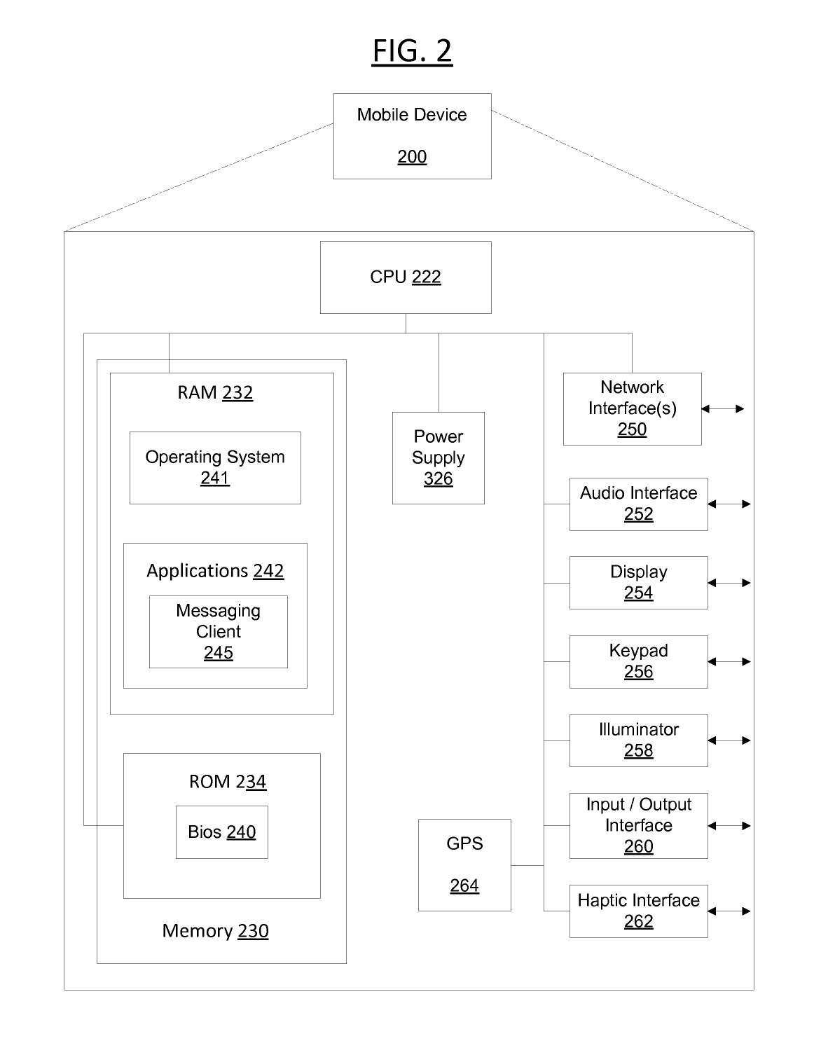

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices 101-104 discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email, VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

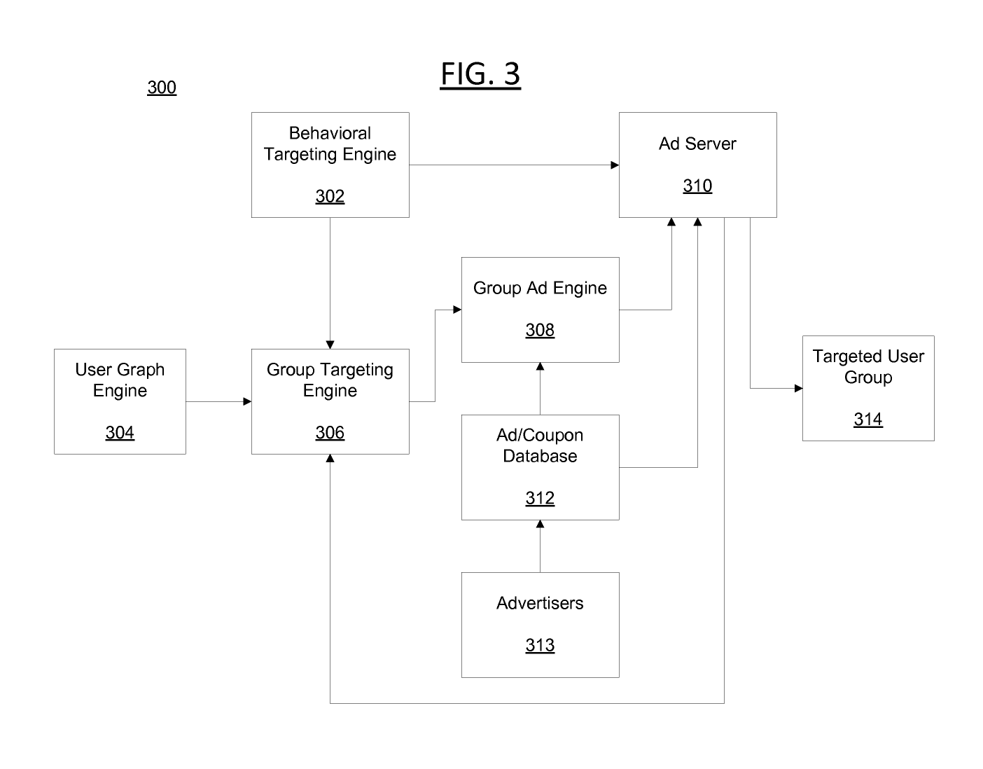

Having described the components of the general architecture employed within the disclosed systems and methods, the components general operation with respect to the disclosed systems and methods will now be described with reference to FIGS. 3-7. FIG. 3 is a block diagram illustrating system 300 of engines that perform the automated generation of targeted advertisements to a group of users. As discussed above, conventional targeted group-buying involves any number of users being able to purchase an advertisement. That is, there is usually no maximum number of buys that initiates the deal. Additionally, there is no personalization or contextual basis for the large group of users being offered the deal. In the present disclosure, the deals, or advertisements, are deployed to a small, targeted group of users that are highly engaged with each other. Additionally, the ads are contextually related to the foundation of engagement between users.

FIG. 3 illustrates a behavioral targeting engine 302, a user graph engine 304, a group targeting engine 306, a group ad engine 308, an ad server 310 and an ad/coupon database 312. It should be understood that the engines discussed herein are non-exhaustive, as additional or fewer engines may be applicable to the embodiments of the systems and methods discussed herein. In some embodiments, the engines could be hosted by a web server, an ad server, a content provider or user computing device, or any combination thereof.

The behavioral targeting engine 302 is configured as a continuous learning engine that compiles data attributes and purchase intent details of a user into a profile for each user. According to some embodiments, a user's activity on a network is continuously monitored and user specific information (or user profile information) is compiled and stored within a user profile for each user, which can include data representing a user's interests and activities (either based on their current viewing and purchasing activities or patterns, or historically based on such information). Such information can be based upon, but not limited to, a user's expressed interests, a user's location, and/or a user's historical or current behavior. This information, in addition to other user profile information generally understood by those of skill in the art (e.g., name, age, gender, address, email address, and the like), can be stored and utilized via the behavioral targeting engine 302 to ascertain a user's interests. As an example, by tracking a user's path through a web site or network of sites, and compiling a profile based at least in part on pages viewed or content purchased, rendered or viewed, information can be collected indicating content, or types of content (e.g., products/services) a user is interested in. A user's interests in a particular type of content can be based upon certain metrics (or scores), including, but not limited to, whether the user likes or dislikes the content (e.g., ratings or rankings the users applies to the context from a social aspect), time spent on the content, frequency the user visits the content or related content, the type of content the user recently visited, the click-through rate (CTR) of the content, and in instances of sets of content, and purchases from product/service providers.

In some embodiments, in addition to such interests being dynamically collected, a user's interests can be pre-defined by the user, or based in part upon the user's location and/or demographics. For example, a user's interests can include products/services for which the user has expressed interest. A user's interests can be predefined by the user, based upon the user's viewing or rendering activity (past, present or projected), or input in real-time during a search request. Indeed, the user's interests can also be dynamically compiled based on the user's search history, viewing history, and/or purchase history. Thus, as discussed in more detail below, the present disclosure leverages the identified user interests of a user into creating targeted advertisements based on compiled (and learned) behaviors of the user.

Thus, as discussed in more detail below, the behavioral targeting engine 302 collects and maintains data attributes and intent details of users derived from the user's profile, the user's activity, and/or the user's behavior and characteristics. The behavioral targeting engine 302 can be implemented using any known or to be known learning techniques and/or algorithms in order to efficiently and properly compile data attributes and intent details related to users on a network.

The user graph engine 304 is configured to continuously monitor a user's activity on a network in order to determine the user's connections with other users. This monitoring computes an engagement metric between the user (e.g., primary user) and the other users over various communication channels (or platforms) available to the primary user. Such channels include, but are not limited to, the user's phonebook (or contact list), emails, instant messages (IMs), and social activities (through social platforms including, but not limited to, Facebook®, Twitter®, and the like), and the like. Indeed, the user graph engine 304 monitors (and analyzes) a user's activities across network platforms, e.g., Yahoo!® network, including search, social, finance, sports, music content, and the like. Thus, for each user, a social circle is established based on the user's connections over available channels with other users. That is, the user graph identifies the channels of communication a user utilizes to communicate with other users, and also identifies those users which are communicating with the primary user. For example, user A interacts with user B over email and IM, interacts with user C via IM and Facebook®, and interacts with user D via Facebook® and Twitter®. Therefore, user A's social circle includes user B, user C and user D, where pairs (or groups) of “friends” are established: users A and B, A and C, A and D.

After establishing a user's social circle or network, the user graph engine 304 computes an engagement score for each pair of friends (or group) within the user's social circle. That is, for each communication channel for which user A communicates with an identified friend, an engagement score is computed reflecting the level of interaction between the users. The level of interaction metric can be based upon the frequency of communication over a channel for a specified period (set by the system, advertiser, content provider, channel platform and/or user). In some embodiments, the frequency of communication (interaction) metric can be updated continuously, and in some embodiments, the frequency metric is based within a predetermined time period. For example, from the above example, user A and user B have connections via email and IM. Therefore, for each channel, e.g., email and IM, a score is computed for user A and user B's connection (relationship) based on the level of communication occurring via each channel. Additionally, it should also be understood that any known or to be known metric for determining a level of communication can be utilized within the systems and methods discussed herein.

In preferred embodiments, connections via certain channels carry more weight for specific users, as they are utilized more frequently; therefore, certain channels will be weighted more (or less) based on the level of usage per user. In preferred embodiments the weights are determined respective all communications by a user; and in some embodiments, weights are specific to certain relationships (or connections) with specific other users. Thus, based on the computations per channel, an overall score for a group (or pair of friends) is computed. This overall score is based on the level of interaction per connection, and each connection's (or channel's) weight. For example, user A uses email more than IM to communicate with all of his friends; therefore, upon computing the engagement score for user A and user B's connection, email will be weighted more than IM. For example, user A uses email 1.5 times more than IM. Therefore, when computing an engagement score for the connection, the computation will involve (IM engagement score) plus (email engagement score)×(1.5).

Therefore, for each pair of friends, an overall score is computed by combining the scores from each channel (or connection). As discussed above, the channels themselves are weighted and the overall score is a combination of the weights and scores. After computation of the overall scores for each group (or pairs of friends), the top pair is retained and identified (or flagged) as a valid candidate for a “dual” person social ad, as discussed in more detail below. Indeed, these tuples of “friends” (pairs of friends/groups) are normalized across the provider's platform (e.g., Yahoo!®), in order to obtain a uniform scoring and advertising targeting model. Furthermore, in preferred embodiments, these groups are small, and preferably limited to 2 users. However, it should be understood that for some channels, and some interactions, groupings could be larger; however, one of skill in the art would understand that groupings will not consist of all users within a “channel” or eligible to contact a user. That is, the user graph engine 304 can be applied to more than two users, in that, by analyzing larger group communication channels, such as emails, social media posts, comments, and the like, top tuples of friends can be identified (or flagged) as prospective candidates for social ads, as discussed herein.

The group targeting engine 306 is configured to perform conjoint analysis of output from the behavioral targeting engine 302 and the user graph engine 304. That is, the group targeting engine 306 receives the information from the behavioral targeting engine 302 regarding user specific information (e.g., interests, attributes and purchase intent details), and receives the information from the user graph engine 304 regarding the groups of users. The group targeting engine 306 compiles this information and determines interests for each group. In some embodiments, the interests for the groups can be based upon the context of the interactions between the users. In some embodiments, the interests for the groups can be derived from overlapping interests identified from each user's profile. By way of example, the identified groups (via the user graph engine 304) include: 1) Bob and John and 2) Bob and Kim. Based on the information for each user within the group (via the behavioral targeting engine 302), overlapping interests shared within each group are determined. For example, Bob and John were chatting about an Xbox. Therefore, the group interests between Bob and John are respective of gaming systems, specifically an Xbox. Thus, the group targeting engine 306 can identify potential gaming system products (or ads) that can be targeted to the group. In a similar manner, by way of another non-limiting example, for the group of Bob and Kim, the interests for this group can be determined based upon their overlapping interests. For example, Bob has previously expressed an interest in cars and basketball, which is identifiable from his online activity at car websites and espn.com. Kim has expressed interested in kayaking and cars from her recent activity at rei.com and car websites. Therefore, there is an overlapping interest in cars. As such, the group targeting engine could identify potential car products targeted for the small active group of Bob and Kim.

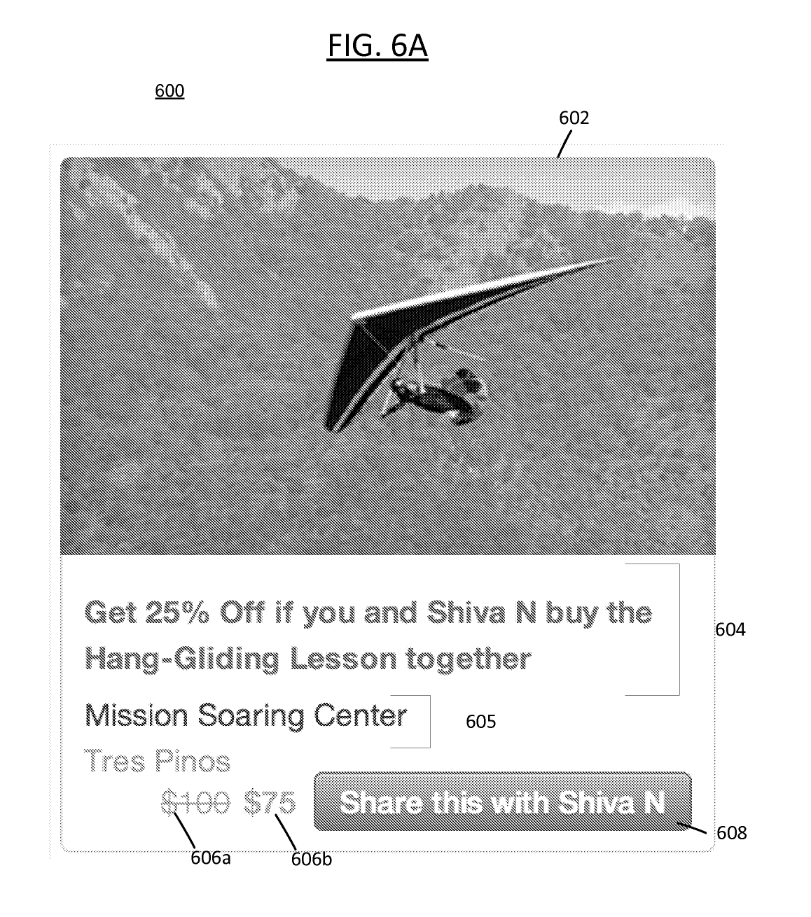

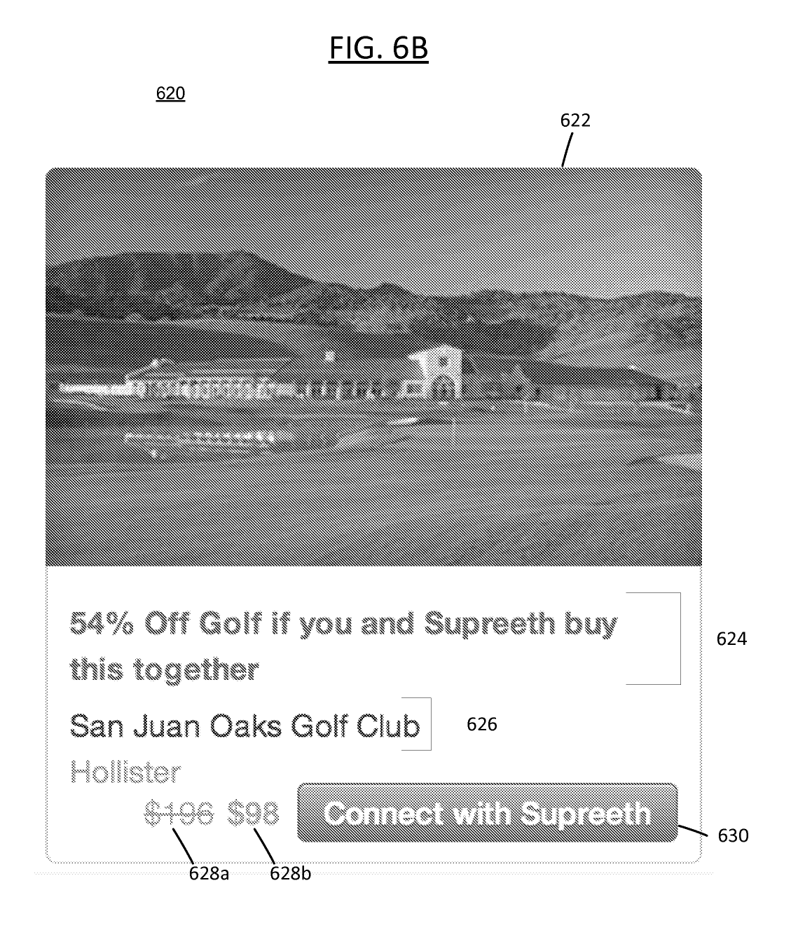

The group ad engine 308 is configured to dynamically generate a group ad creative specific to the interests of the group. That is, the group ad engine 308 receives compiled information from the group targeting engine 306 respective a user group and the group's interests, and creates an advertisement tailored to the users of the group, as discussed in more detail below. For example, between the group of users: Bob and Kim, the interests were cars. Therefore, the group ad engine can retrieve (or request then receive) ad information related to cars from the ad/coupon database 312. The ad/coupon database 312 stores ad campaign content and materials created by advertisers 313. These materials include ad templates and ad related information, such as the content of the ad (e.g., images, text, sounds and the like), and the deal being offered, including specific “call outs” for individuals being served the ad. Therefore, after identifying the topic as “cars,” the group ad engine 308 polls the ad database 312 for advertising information related to cars. In response, the group ad engine 308 receives an ad template related for displaying a car advertisement (or deal or coupon), and content specific to cars, as provided by an advertiser 313. Examples of such ads (or deals/coupons) are illustrated in FIGS. 6A-6B, and discussed in more detail below. The ad creative generated by the group ad engine 308 provides connectivity among group users' interests thereby acting as a catalyst to a completed purchase. Therefore, the advertisement created by the group ad engine is then served to at least one user within the targeted group 314 by the ad server 310. In some embodiments, the ad server is further configured to evaluate the effectiveness of the group ads in comparison to traditional ads. That is, the ad server performs analysis on the served group ad(s) to determine whether the users being served the ads (or deals) are taking advantage of them more frequently than traditional targeted advertisements. In some embodiments, the ad server 310 may determine that the group ad is not economically viable, in that the ad is not resulting in additional buys (or purchases) of a product or service; therefore the ad server 310 may then replace the ad with a targeted advertisement (e.g., traditional advertisement). Should this occur, the ad server 310 would communicate such information back to the group targeting engine 306 which includes this information upon determining interests of a group, as discussed above. That is, in addition to the group targeting engine accounting for a groups interests, the engine 306 would further account for (and in some embodiments weigh) the effectiveness of a group ad related to an interest group in determining an interest (topic) to provide to the group ad engine 308.

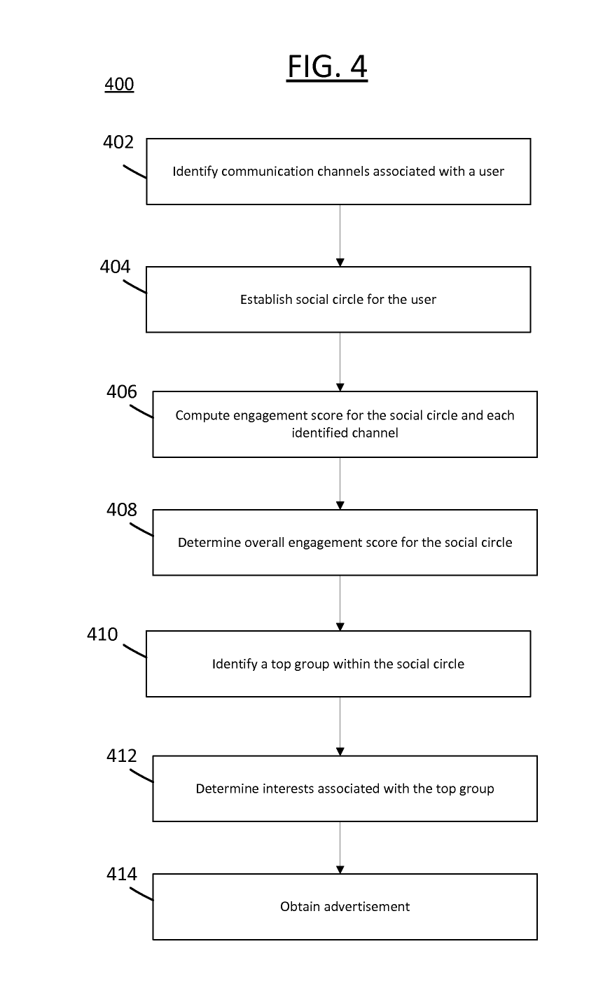

FIG. 4 is a flow chart illustrating the process 400 for performing the systems and methods discussed herein. As discussed above, the present disclosure provides an automated system and method to improve user engagement involving purchasing products/services. Process 400 details the steps performed by the components of system 300 for creating (and/or delivering) advertisements that identify a user's friends with a targeted product. Process 400 provides relevant advertisements to members of a targeted online group, where the members of the group share common interests, behaviors, preferences, online activities, and the like. Indeed, the advertisements, which can include deals or coupons for products or services, include “call outs” to the user(s) receiving the ad. The “call out” is a call to action for the user to consummate the transaction, as discussed below. The call to action encourages product (or brand) engagement by specifically identifying another user from an identified group of users (e.g., user's friends or other users who have an established relationship with the user) that may be interested in a product; thus, providing an initial dialogue between the friends over the targeted product.

Process 400 begins in Step 402, where for a user (referred to as a first user), channels of communication for which the first user communicates with other users are identified. That is, the channels of communication associated with a first user are identified. As discussed above, examples of such channels include, but are not limited to, emails, instant messages (IMs), and social activities (through social platforms including, but not limited to, Facebook®, Twitter®, and the like), and the like. Additionally, as discussed above, the process 400 will be discussed respective of a single user, and such user's identified group(s); however, it should not be construed to limit the systems and methods discussed herein to a single user. That is, for all users on a network, the systems and methods discussed herein (e.g., Process 400) can be applied in ultimately serving social advertisements.

After identifying the channels of communication for the first user, a social circle is established for the first user. Step 404. That is, as discussed above, a user's social circle includes the other user's the first user interacts with via the identified channels of communication. The social circle includes groups of users respective the first user. For example, Jim uses email, Twitter® and Facebook®, and communicates with Jerry, Walt and Roy via each platform. Therefore, Jim's social circle includes Jerry, Walt and Roy. The social circle is established and it is noted that Jim has pairings (or groups) with Jerry, Walt and Roy, respectively, via the channels: email, Twitter® and Facebook®. As discussed above, in preferred embodiments, groups of users include two (or few) users, as this encourages product (or brand) engagement by specifically identifying “friends” that may be interested in a product; thus, providing an initial dialogue between the friends over the targeted product, as discussed below.

In Step 406, an engagement score is computed for each user over each channel identified in Steps 402 and 404. That is, for each user, an engagement score is computed regarding the level of interaction between each user over each channel. Therefore, from the above example, a score is computed based on Jim's interactions with Jerry over email. A score is also computed for Jim's interactions with Jerry on Twitter® and Facebook®. Following this, scores are also computed for Walt and Roy, respectively, according to their level of interaction with Jim via each channel. Therefore, individual engagement scores will be computed for Jim's interactions with Walt over email, Twitter® and Facebook®. Also, individual engagement scores will be computed for Jim's interactions with Roy over email, Twitter® and Facebook®.

As discussed above, certain channels may carry more weight as they are utilized more frequently. Therefore, certain channels will be weighted more (or less) based on the level of usage per user. Thus, based on the engagement score per channel for each user calculated in Step 406, an overall engagement score for a group (or pair of friends) is computed. Step 408. This overall score is based on the level of interaction per connection, and each connection's (or channel's) weight. For example, Jim uses email more than Twitter® and Facebook® to communicate with all of his friends; therefore, upon computing the engagement score for Jim and Walt's connection, the engagement score for the email channel will be weighted more than the scores for Twitter® and Facebook®. For example, Jim uses email 2.5 times more than Twitter® and Facebook®; therefore, when computing an engagement score for the overall Jim and Walt connection, the computation will involve: (email engagement score)×(2.5) plus (Twitter® engagement score) plus (Facebook® engagement score). Therefore, for each pair of friends, an overall score is computed by combining the scores from each channel (or connection).

In Step 410, the top pair (or group) is identified based on the overall score. From the above example, if the overall score for the relationships of Jim-Jerry, Jim-Walt and Jim-Roy resulted in scores of: 80, 85 and 90 (scores for illustrative purposes and not intended to limit the scoring the process 400), respectively, then the Jim-Roy relationship would be identified as having the strongest overall connection. In Step 412, for the top pair identified in step 410, the interests for each group are identified. As discussed above, these interests may be based upon the context for which the connection was established; or may be resultant of identifying overlapping interests determined from each user's profile.

In Step 414, an advertisement is obtained, generated or provided, or identified or selected from a group consisting of available ads from an ad inventory, corresponding to the context determined in Step 412. That is, an advertisement is generated for an identified group having the highest overall engagement score, where the ads' context is also determined based upon the user's engagement. From the above example, the determined group with the highest engagement score was Jim-Roy. Also, it was determined, from step 412, that the context of their connection (or engagement) was golfing; therefore, an advertisement will be generated displaying a deal or coupon for a golfing excursion, as discussed in more detail below.

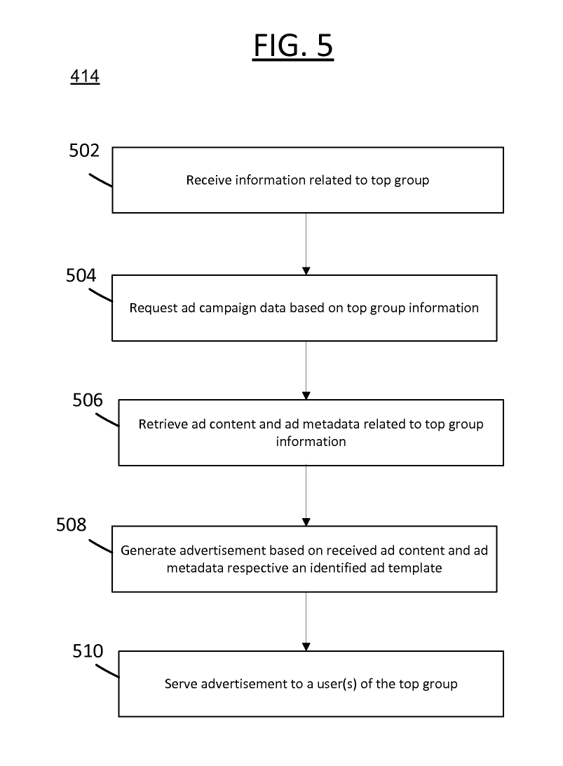

FIG. 5 illustrates the steps performed for generating the advertisement, as discussed in Step 414. In Step 502, the group ad engine 308 receives information from the group targeting engine 306 respective the identified group (from Step 410) and the group's interests (Step 412). The information for the identified group can include, but is not limited to, the identifiers (or identifying information) related to each user within a group. Indeed, the information for the identified group can also include the means (to serve the ad) for communicating with the users of the group (e.g., email address, IM username, phone number, Twitter® handle, Facebook® user name or URL, and the like). The contextual information (related to the group interests) can include, but is not limited to, data and/or metadata identifying a contextual topic or content type. For example, contextual data can include data indicating a specific context, e.g., kayaking, as the group's interest.

In Step 504, a request is communicated to the ad/coupon database 312 for advertising content respective an ad campaign that relates to the identified interests of the group (e.g., identified context). As discussed above, the ad/coupon database 312 includes advertising templates and ad metadata and ad content related to advertising campaigns generated by advertisers 313. The ad templates can be included within the ad metadata and content, as they provide the configuration for providing an advertisement according to the directive of the advertiser 313. The ad metadata can include the price of the product/service, discount, time period for deal, expiration date, and the like. The ad content can include, but is not limited to, content to be displayed within the ad (e.g., images, video, sound, and the like).

In Step 506, based on the requested context, ad information (including ad content and ad metadata) are retrieved (or received). Additionally, the ad information also includes identifying an ad template to be used for serving (and displaying) the advertisement. Thus, the group ad engine 308 dynamically generates an advertisement based on the received ad information, in Step 508, that is served to at least one user of the identified group, in Step 510. In some embodiments the ad can be published on a provider's website, or distributed to a user(s) of the group (via any one of the identified communication channels identified in Step 402). In some embodiments, the ad will be served to only one user of the group (or pair), and in some embodiments, the ad will be served to all users of the group. Serving ads solely to one user of the group can increase the effectiveness of the ad by encouraging a dialogue between the users respective the ad. For example, user A receives the ad respective the group of user A and user B. The ad is contingent upon both user A and user B purchasing the discount; therefore, user A is triggered to connect with user B regarding the product/service provided by the ad, thereby effectuating a dialogue about the product/service.

FIGS. 6A-6B are illustrations of non-limiting examples of obtained, generated or selected, and displayed ads produced from system 300, and processes 400 and 500, discussed above. As illustrated in FIG. 6A, the ad 600 includes the content to be displayed respective the identified interest (or context) 602, a message providing instructions for the ad (or deal) 604, the location where the use the deal 605, the original price for the product/service 606a, and the discounted price 606b. The message 604 includes the text “Get 25% off if you and Shiva N buy the hang-gliding lesson together.” The message is the incentive for the user to purchase the deal with user “Shiva N”. That is, the original price (item 606a) was $100 dollars, and after the 25% incentive, the discounted price (item 606b) will be $75 should the other user also buy the deal. Additionally, the ad 600 provides a “call out” 608. The call out provides the user with the ability to share the deal with Shiva. In some embodiments, the call out generates the serving of the advertisement (or delivery of the ad) to Shiva. Additionally, as discussed above, the call out 608 provides a means for communicating with Shiva. The call out 608 also enables the users of the group to consummate the deal collectively. That is, the ad (or deal) is a dual advertisement. In preferred embodiments, the ad facilitates communication between users of the group to discuss the ad. The call out 608 facilitates a communication session whereby each user can communicate with each other respective the ad. For example, the call out 608 can generate an IM window, or new email template for communicating with the other user. That is, the ad “call out” can generate a platform to discuss the ad/deal with the other user of the group.

Similarly, FIG. 6B illustrates an ad (or deal) 620. The context of the ad relates to golfing, thereby the content 622 displays a golf course. Message 624 instructs the receiving user that “54% off Golf if you and Supreeth buy this together.” The location 626 is the “San Juan Oaks Golf Club.” The original price (item 628a) was $196, and now the discounted rate is $98 (item 628b). The call out 630 provides the means for the user to connection with user Supreeth regarding the deal. That is, as discussed above, the deal enables the user the contact with Supreeth to discuss the deal (and ultimately receive the discounted rate 628b) via interaction with the call out 630.

Therefore, the processes 400 and 500 discussed above, which result in a micro-targeted contextually tailored advertisements (or deals), as illustrated in FIGS. 6A-6B, for a highly-engaged small group of users, implements social signals to personalize the messages (604, 624) within ad creatives that also call out individuals to action. The disclosed systems and methods encourage a highly engaged group to interact and converse about the ad/deal which will result in an influx of conversations about the advertised products/services. Additionally, engagement within the same group around the ad/deal will increase as the creatives will call out individuals for action (e.g., call outs, 608, 630). Thus, the present disclosure provides interactive advertisements for a group of users, whereby the ads facilitate social interactions respective the advertised products and/or services.

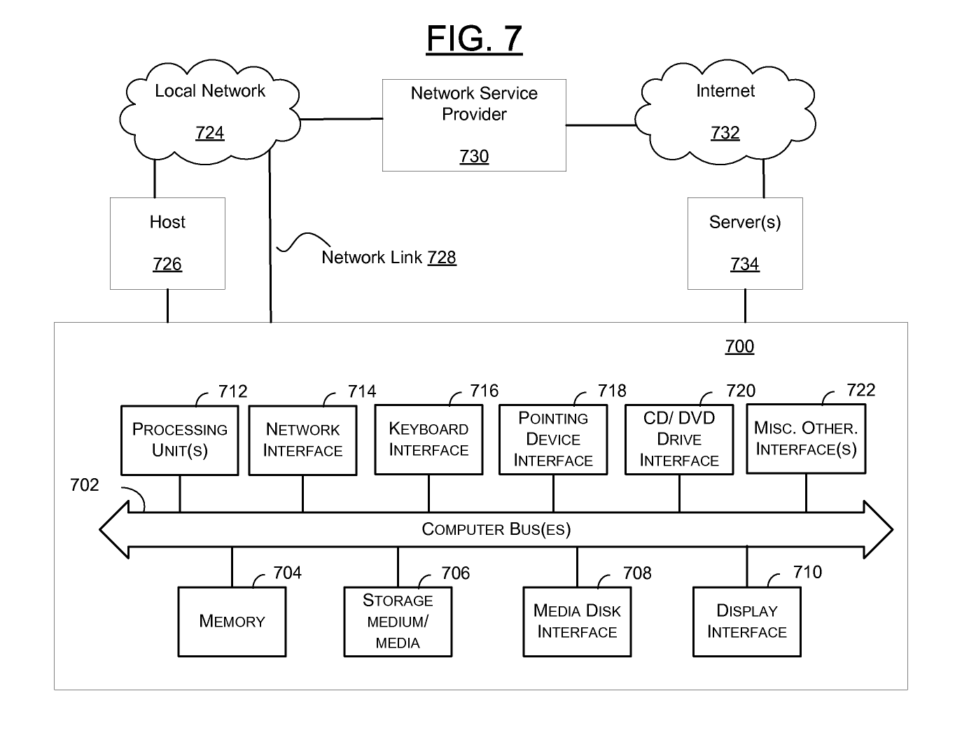

As shown in FIG. 7, internal architecture 700 includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access memory (RAM), run-time transient memory, read only memory (ROM), media disk drive interface 720 as an interface for a drive that can read and/or write to media including removable media such as floppy, CD-ROM, DVD, media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces and a universal serial bus (USB) interface.

Memory 704 interfaces with computer bus 702 so as to provide information stored in memory 704 to CPU 712 during execution of software programs such as an operating system, application programs, device drivers, and software modules that comprise program code, and/or computer executable process steps, incorporating functionality described herein, e.g., one or more of process flows described herein. CPU 712 first loads computer executable process steps from storage, e.g., memory 704, computer readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 728 typically provides information communication using transmission media through one or more networks to other devices that use or process the information. For example, network link 728 may provide a connection through local network 724 to a host computer 726 or to equipment operated by a Network or Internet Service Provider (ISP) 730. ISP equipment in turn provides data communication services through the public, worldwide packet-switching communication network of networks now commonly referred to as the Internet 732.

A computer called a server host 734 connected to the Internet 732 hosts a process that provides a service in response to information received over the Internet 732. For example, server host 734 hosts a process that provides information representing video data for presentation at display 710. It is contemplated that the components of system 700 can be deployed in various configurations within other computer systems, e.g., host and server.

At least some embodiments of the present disclosure are related to the use of computer system 700 for implementing some or all of the techniques described herein. According to one embodiment, those techniques are performed by computer system 700 in response to processing unit 712 executing one or more sequences of one or more processor instructions contained in memory 704. Such instructions, also called computer instructions, software and program code, may be read into memory 704 from another computer-readable medium 706 such as storage device or network link. Execution of the sequences of instructions contained in memory 704 causes processing unit 712 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
determining, via a computing device, connections over a network between a first user and a plurality of other users, said determination of said connections comprising identifying a plurality of communication channels used for interactions between said first user and said other users;
determining, via the computing device, user pairs based on said connections, each user pair comprising said first user and one of said other users, each pair associated with at least one communication channel of said plurality of communication channels;
computing, via the computing device, an engagement score for each user pair, said engagement score is based upon a level of interaction occurring between said first user and each other user over each associated communication channel;
determining, via the computing device, an overall engagement score for each user pair, said determination of the overall engagement score comprising combining each engagement score from each associated communication channel for each user pair;
identifying, via the computing device, a top pair based upon the overall engagement score for each pair;
determining, via the computing device, a shared interest associated with said top pair; and
generating, via the computing device, an advertisement for said top pair based on said shared interest.

2. The method of claim 1, wherein said determination of said overall score further comprising:
determining a weight for each of said plurality of communication channels, wherein said weight is based on a frequency said first user utilizes each channel; and
applying said weight as a factor to said engagement score for each associated communication channel during said combining each engagement score.

3. The method of claim 1, wherein said shared interest is based upon said interactions occurring between the top pair, wherein said shared interest relates to a context within said interactions.

4. The method of claim 1, further comprising:
monitoring activity of each user on said network, wherein said activity provides an indication of at least one interest associated with each user; and
compiling a user profile for each user based on said activity.

5. The method of claim 4, wherein said determination of said shared interest comprises:
identifying an interest associated with each user of said top pair from each user's profile; and
determining said shared interest based upon an identified overlap of said interest associated with each user of said top pair.

6. The method of claim 1, further comprising:
requesting ad information from an advertisement database that corresponds with said shared interest, said ad information comprising ad content and ad metadata provided by an advertiser;
receiving said ad information, said received ad information further comprising an ad template for displaying said advertisement, said ad template comprising a layout for displaying said ad content; and
generating said advertisement in accordance with said ad template.

7. The method of claim 1, wherein said generating the advertisement comprises including a “call out” within said advertisement to said first user with reference to the other user of said top pair.

8. The method of claim 7, wherein said call out comprises an ability for said first user to share said advertisement with the other user of said top pair.

9. The method of claim 7, wherein said call out comprises an ability for said first user to initiate a communication with the other user of said top pair from said advertisement, said communication occurring over one of said plurality of communication channels.

10. The method of claim 1, further comprising:
communicating said advertisement to only one user of said top pair.

11. The method of claim 1, wherein said advertisement is a deal available to said users of the top pair.

12. A non-transitory computer-readable storage medium tangibly encoded with computer-executable instructions, that when executed by a process, perform a method comprising:
determining connections over a network between a first user and a plurality of other users, said determination of said connections comprising identifying a plurality of communication channels used for interactions between said first user and said other users;
determining user pairs based on said connections, each user pair comprising said first user and one of said other users, each pair associated with at least one communication channel of said plurality of communication channels;
computing an engagement score for each user pair, said engagement score is based upon a level of interaction occurring between said first user and each other user over each associated communication channel;
determining an overall engagement score for each user pair, said determination of the overall engagement score comprising combining each engagement score from each associated communication channel for each user pair;
identifying a top pair based upon the overall engagement score for each pair;
determining a shared interest associated with said top pair; and
generating an advertisement for said top pair based on said shared interest.

13. The non-transitory computer-readable storage medium of claim 12, wherein said determination of said overall score further comprising:
determining a weight for each of said plurality of communication channels, wherein said weight is based on a frequency said first user utilizes each channel; and
applying said weight as a factor to said engagement score for each associated communication channel during said combining each engagement score.

14. The non-transitory computer-readable storage medium of claim 12, wherein said shared interest is based upon said interactions occurring between the top pair, wherein said shared interest relates to a context within said interactions.

15. The non-transitory computer-readable storage medium of claim 12, further comprising:
monitoring activity of each user on said network, wherein said activity provides an indication of at least one interest associated with each user; and
compiling a user profile for each user based on said activity.

16. The non-transitory computer-readable storage medium of claim 15, wherein said determination of said shared interest comprises:
identifying an interest associated with each user of said top pair from each user's profile; and
determining said shared interest based upon an identified overlap of said interest associated with each user of said top pair.

17. The non-transitory computer-readable storage medium of claim 12, further comprising:
requesting ad information from an advertisement database that corresponds with said shared interest, said ad information comprising ad content and ad metadata provided by an advertiser;
receiving said ad information, said received ad information further comprising an ad template for displaying said advertisement, said ad template comprising a layout for displaying said ad content; and
generating said advertisement in accordance with said ad template.

18. The non-transitory computer-readable storage medium of claim 12, wherein said generating the advertisement comprises including a “call out” within said advertisement to said first user with reference to the other user of said top pair,
wherein said call out comprises an ability for said first user to share said advertisement with the other user of said top pair,
wherein said call out comprises an ability for said first user to initiate a communication with the other user of said top pair from said advertisement, said communication occurring over one of said plurality of communication channels.

19. A system comprising:
at least one computing device comprising:
memory storing computer-executable instructions; and
one or more processors for executing said computer-executable instructions, comprising:
determining connections over a network between a first user and a plurality of other users, said determination of said connections comprising identifying a plurality of communication channels used for interactions between said first user and said other users;
determining user pairs based on said connections, each user pair comprising said first user and one of said other users, each pair associated with at least one communication channel of said plurality of communication channels;
computing an engagement score for each user pair, said engagement score is based upon a level of interaction occurring between said first user and each other user over each associated communication channel;
determining an overall engagement score for each user pair, said determination of the overall engagement score comprising combining each engagement score from each associated communication channel for each user pair;
identifying a top pair based upon the overall engagement score for each pair;
determining a shared interest associated with said top pair; and
generating an advertisement for said top pair based on said shared interest.

20. The system of claim 19, further comprising:
requesting ad information from an advertisement database that corresponds with said shared interest, said ad information comprising ad content and ad metadata provided by an advertiser;
receiving said ad information, said received ad information further comprising an ad template for displaying said advertisement, said ad template comprising a layout for displaying said ad content; and
generating said advertisement in accordance with said ad template.
